(19) United States
(12) Patent Application Publication
(10) Pub. No.: US 2025/0348300 A1
(43) Pub. Date: Nov. 13, 2025

(54) SYSTEM AND METHOD FOR AI-ASSISTED MONITORING AND VALIDATION FOR NETWORK UPGRADES

(71) Applicant: Aviz Networks, Inc., San Jose, CA (US)

(72) Inventors: Chidambaram Bhagavathiperumal, Livermore, CA (US); Vishal Shukla, San Jose, CA (US); Ashok Kumar Murthy, Chennai (IN)

(73) Assignee: Aviz Networks, Inc., San Jose, CA (US)

(21) Appl. No.: 18/658,836

(22) Filed: May 8, 2024

(51) Int. Cl. G06F 8/65

(52) U.S. Cl. CPC G06F 8/65

(57) ABSTRACT

Embodiments of the present disclosure disclose a system that is configured to learn the normal operating parameters of the network devices in a network infrastructure over an extended period of time, thereby establishing the “baseline” for the network to provide the intended benefits.

According to an embodiment of the present disclosure, a baseline variable is updated at regular intervals to make sure it reflects the actual network requirements for the applications using it. After a network upgrade, which can either be new hardware or software change, the system utilizes the baseline to automatically determine if important challenges are addressed.

### BACKGROUND

Timely network upgrades in data centers are mission critical for addressing and responding with demands which may include massively increased data volumes, requests for faster data processing, and utilization of cloud services. Such network upgrades can require changes, modifications, or upgrades of higher-speed networking switches, as well as modifications to mission critical software involving network operating systems and firmware for security vulnerabilities.

Conventional systems typically utilize system monitoring for various metrics and require manual effort to establish the baseline for the network behavior and post upgrade doing the validation to make sure the upgrade is successful, a process which is time-consuming and prone to errors. What is needed is an automated solution for ongoing monitoring and validation of networks and providing timely network upgrades.

### SUMMARY

The present disclosure provides systems and methods for addressing the challenges described above. The present disclosure further provides automated solutions for continuous monitoring and validation for networks.

Embodiments of the present disclosure disclose a system that is configured to learn the normal operating parameters of the network devices in a network infrastructure over an extended period of time, thereby establishing the “baseline” for the network to provide the intended benefits.

According to an embodiment of the present disclosure, a baseline variable is updated at regular intervals to make sure it reflects the actual network requirements for the applications using it. After a network upgrade, which can either be new hardware or software change, the system utilizes the baseline to automatically determine if important challenges are addressed.

According to an embodiment, a validation procedure is utilized to determine if the upgrade is successful or not. In case of any deviations from the baseline, it is reported immediately to the user or administrator. It can be appreciated that the present disclosure provides a solution by automating the monitoring and validation process, using AI to enhance accuracy and efficiency.

By automating the process of monitoring and validating network upgrades, the methods described in the present disclosure allow network administrators and operators to ensure network health and performance for intended benefits after the upgrade.

Further embodiments disclose interoperability with an LLM to provide a scalable, efficient solution for managing the complexities of network upgrades, reducing downtime, and ensuring continuity of service.

### BRIEF DESCRIPTION OF THE DRAWINGS

FIG. 1 is an architecture diagram of an embodiment according to the present disclosure.

FIG. 2 is a flowchart of an example process 200 according to an embodiment of the present disclosure.

### DETAILED DESCRIPTION

The present disclosure provides systems and methods configured to comprehensively monitor a configured set of critical parameters to establish a baseline configuration, thereby helping to support optimal network performance and security.

Embodiments of the present disclosure may include one or more high-performance servers equipped with multi-core processors and at least 64 GB RAM to handle the described data processing and analysis steps. Embodiments of the system further disclosure retrieval optimized storage solutions to manage the large volumes of data collected, such as SSDs for fast data retrieval and HDDs for long-term data storage, together with a database service configured for the cloud. Network components, including routers, switches, and dedicated firewalls, are optimized for high throughput and low latency to maintain network performance while supporting comprehensive monitoring activities.

For the software structure, the system may include a comprehensive monitoring solution capable of tracking real-time metrics across various network devices and services. This solution is built on a modular architecture, allowing for easy customization and extension by network operators, and integrating capabilities such as data collection, processing, and real-time analytics to detect and alert on potential issues. According to an embodiment, said system also includes a visualization tool to customize security alerts, enabling operators to create and modify dashboards to reflect different network architectures and to highlight key performance metrics and security alerts.

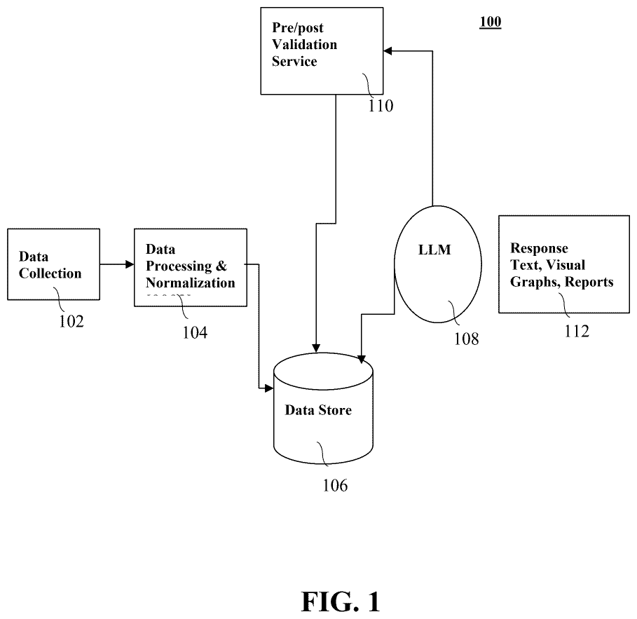

FIG. 1 is an architecture diagram according to an embodiment of the present disclosure. First, by utilization data collection module 102, periodic data collection from the network is implemented using monitoring protocols or APIs that are executed on a server device. The system enables automated monitoring and validation of network upgrades using AI to compare pre- and post-upgrade network behavior against established baselines. In the design of a network traffic monitoring system, the functionality can be organized into distinct modules that utilize various protocols, forming an integrated framework for efficient data management and analysis.

Data Collection Module 102 is essential for gathering network data from a range of devices across the network. This module may utilize SNMP for collecting basic metrics and status information from network devices according to an embodiment of the present disclosure. Additional embodiments may utilize NetFlow and sFlow for capturing detailed data regarding the traffic flows within the network, configured to periodically send flow records to the system. Packet sniffing can also be integrated for deep packet inspection, capturing all packets passing through specified points in the network. ICMP may also be utilized within this module for diagnostic and control purposes to help identify connectivity issues.

Following collection, the Data Processing Module 104 takes over to handle the incoming data for uniform feed to the LLM 108. Data Processing Module 104 is tasked with aggregating data points from various sources, which helps in reducing the volume of data and simplifies management. It also normalizes the data formats collected via different protocols to ensure uniformity in analysis and storage. This involves tasks like converting timestamps and standardizing metrics to a common scale, thereby preparing the data for effective analysis and reporting.

Together, these modules form a comprehensive system that not only collects but also processes network traffic data efficiently, allowing for effective monitoring, troubleshooting, and optimization of network performance.

Data store 106 handles saved data from the Data Processing Module and also receives validation information from Pre/post validation module 110.

The pre/post validation module 110 can comprise a request from a network operator to verify whether the upgrade is successful. It further comprises a validation service which performs the various metrics to verify the success of the upgrade process and provides the detailed information on any deviations. LLM 108 interacts with the user 112 as well as provides feeds into the Pre/post validation module 108 and data store 106.

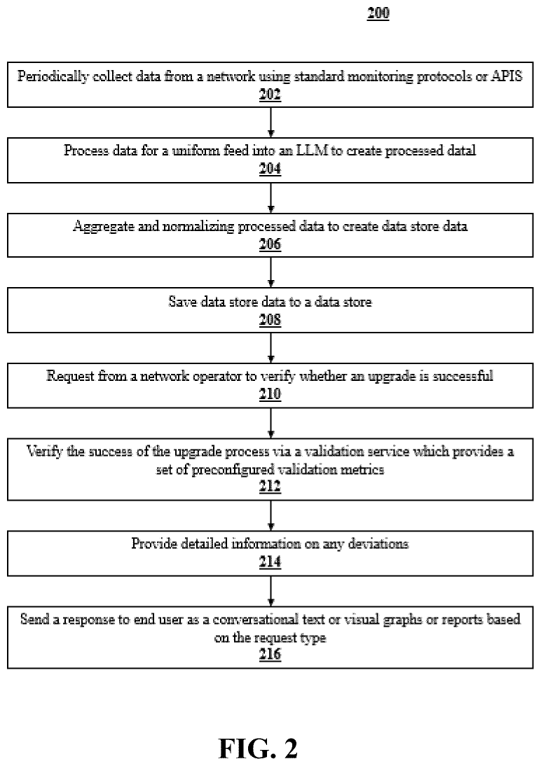

FIG. 2 is a flowchart of an example process 200. In some implementations, one or more process blocks of FIG. 2 may be performed by a server device.

As shown in FIG. 2, process 200 may include periodically collecting data from a network using standard monitoring protocols or APIS (block 202). As also shown in FIG. 2, process 200 may include processing data for a uniform feed into an LLM to create processed data (block 204). For example, a server may process data for a uniform feed into an LLM to create processed data, as described above. As further shown in FIG. 2, process 200 may include transformational actions to prepare transformed data for a data store (block 206). For example, the server may aggregate and normalize processed data to create data store data, as described above. As also shown in FIG. 2, process 200 may then affirmatively save the processed data (block 208). For example, the server may save the data store data to a data store, as described above. As further shown in FIG. 2, process 200 may include a verification step as to an upgrade (block 210). For example, the server may request from a network operator to verify whether an upgrade is successful. As also shown in FIG. 2, process 200 may include verifying the success of the upgrade process via a validation service which provides a set of preconfigured validation metrics (block 212). As further shown in FIG. 2, process 200 may include providing detailed information on any deviations (block 214). As also shown in FIG. 2, process 200 may include sending a response to the end user (block 216). For example, the server may send a response to end user as a conversational text or visual graphs or reports based on the request type, as described above. As further shown in FIG. 2, process 200 may send a response to end user as a conversational text or visual graphs or reports based on the request type.

Although FIG. 2 shows example blocks of process 200, in some implementations, process 200 may include additional blocks, fewer blocks, different blocks, or differently arranged blocks than those depicted in FIG. 2. Additionally, or alternatively, two or more of the blocks of process 200 may be performed in parallel.

Together, these components form a resilient framework capable of adapting to varying network demands and configurations, ensuring that the system remains effective across different operational environments.

According to embodiments of the present disclosure, among the key parameters monitored are the operational status of network ports, which is essential for maintaining connectivity and troubleshooting issues. The method also tracks software versions to ensure that all network components are up-to-date and secure against known vulnerabilities. Additionally, the monitoring of the number of Border Gateway Protocol (BGP) neighbors is included to manage network routing complexity and stability.

This dynamic monitoring structure can adapt to the evolving needs of the network, providing a robust tool for network administrators to maintain system integrity and efficiency. It can be appreciated that such a structure significantly advances the process of automatic updates, offering a robust, intelligent, and secure method to maintain and enhance networked systems. It is a notable improvement over traditional update methods, aligning with the need for high reliability and performance in modern technological environments.

According to an embodiment, the method utilizes a plurality of monitoring tools to collect the necessary data to create the baseline. The collected data is processed, normalized, and stored in the database service provided by the method.

According to an embodiment the method includes an advanced monitoring suite for traffic parameters, which are then implemented for assessing network health, capacity, and performance metrics. According to an embodiment, some traffic-related metrics monitored are packets transmitted and packets received, and tracking these metrics is used for identifying traffic patterns and pinpointing potential bottlenecks or failures in network segments. By analyzing these metrics, network administrators can ensure efficient data flow and troubleshoot issues related to packet loss or delays.

According to an embodiment, another important parameter that the method monitors is bandwidth utilization. In one embodiment, the bandwidth utilization metric measures the amount of bandwidth consumed over a given period and is utilized by the method for capacity planning and quality of service (QOS) management, among other utilizations. Monitoring bandwidth utilization helps prevent network congestion and ensures that bandwidth is allocated efficiently among various applications and services.

Additionally, according to an embodiment the method enhances network traffic insights by monitoring sampled flows. This process involves collecting data samples from network traffic to analyze trends and patterns without requiring full traffic capture, which can be resource intensive. Sampled flow data is then utilized for detecting anomalies, understanding user behavior, and enhancing network security measures.

The proposed system integrates robust security monitoring features to protect network integrity and ensure compliance with organizational policies. Key security parameters monitored by the system include Access Control List (ACL) rules and storm control mechanisms, both of which play vital roles in safeguarding the network environment.

Access Control List (ACL) rules are critical for defining and enforcing security policies on the network. By monitoring ACL rules, the system ensures that all data packets meet predefined criteria before they are allowed access to network resources. This is essential for preventing unauthorized access and mitigating potential security threats. The system's ability to monitor and audit ACL configurations helps network administrators quickly identify and rectify misconfigurations that could lead to security vulnerabilities.

Storm control is another important security feature monitored by the system according to an embodiment of the present disclosure. This mechanism helps prevent traffic disruptions caused by broadcast storms, which occur when large numbers of broadcast or multicast packets overwhelm the network. By monitoring storm control settings, the system can detect and mitigate abnormal traffic patterns that might indicate a denial of service (DOS) attack or other network issues. This proactive monitoring helps maintain network stability and prevents the degradation of network services.

The proposed system offers extensive health monitoring capabilities focusing on the stability and performance of control plane protocols, which are crucial for the efficient operation of the network. These protocols, including Border Gateway Protocol (BGP), Link Aggregation Control Protocol (LACP), and VXLAN Tunnel Endpoint (VTEP), are pivotal in maintaining connectivity and ensuring data travels securely across the network infrastructure.

Monitoring the health of BGP is important as it is a protocol responsible for making routing decisions based on paths, network policies, or rule sets, which allows for data and information routing between autonomous systems (AS) on the internet. By tracking BGP sessions, the system can detect instabilities or failures in route propagation and prevent potential disruptions that might affect network performance.

According to an embodiment, LACP is used to provide aggregation of multiple network connections in parallel to increase the link capacity and enhance redundancy. Monitoring LACP ensures that all links are active and properly configured to handle the expected traffic load without causing any bottleneck or failure in the data paths. This may be an optional feature to be employed only in environments where high data availability and bandwidth are required.

According to a further embodiment, VTEPs are provided to implement network virtualization and act as endpoints for VXLAN tunnels, wherein the VTEPS are monitored. Monitoring VTEPs includes ensuring that tunnels are established and maintained correctly, providing secure and efficient encapsulation and routing of traffic within the virtualized networks. It can be appreciated that this monitoring helps in identifying any misconfigurations or issues in the overlay network that could compromise data traffic flow.

Together, these monitoring capabilities are implemented in a targeted process of traffic management, which thus enables network administrators to maintain optimal network operations and make informed decisions regarding network upgrades and security protocols.

The proposed system is configured to utilize the described monitoring tools to collect the necessary data to create the baseline. The collected data is then processed, normalized, and stored in the database service provided by the system.

According to an embodiment, the system provides output to the user in following formats:
Textual responses
Visual Graphs detailing pre/post upgrade behavior
Tabular summarization of each metrics for pre/post upgrade behavior
Report highlighting the deviations between baseline and actuals.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A method, comprising:
periodically collecting network data, by a collection device, from a network using an API to create collected network data;
processing collected network data for a uniform feed into an LLM to create processed data;
aggregating and normalizing processed data and saving to a data store as a baseline variable;
requesting from a network operator to verify whether an upgrade action is successful;
verifying success of the upgrade action via a validation service which provides a set of preconfigured validation metrics;
providing detailed information on any deviations;
sending a response to end user as a conversational text or visual graphs or reports based on request type.

2. The method of claim 1, wherein metrics further comprise the number of BGP neighbors.

3. The method of claim 2, wherein metrics further comprise storm control.

4. The method of claim 3, further comprising updating the baseline variable at regular intervals to verify it reflects actual network requirements for applications.

5. The method of claim 4, further comprising utilizing the baseline variable, after the upgrade action which can either be new hardware or software change, to automatically determine if one or more predetermined milestones are addressed.

6. The method of claim 4, wherein in case of any deviations it is reported immediately to a user or administrator.

7. A device comprising:
one or more processors configured to:
periodically collect network data, by a collection device, from a network using an API to create collected network data;
process collected network data for a uniform feed into an LLM to create processed data;
aggregate and normalize processed data and save to a data store as a baseline variable;
request from a network operator to verify whether an upgrade action is successful;
verify success of the upgrade action via a validation service which provides a set of preconfigured validation metrics;
provide detailed information on any deviations;
send a response to end user as a conversational text or visual graphs or reports based on request type.

8. The device of claim 7, wherein metrics further comprise the number of BGP neighbors.

9. The device of claim 8, wherein metrics further comprise storm control.

10. The device of claim 9, wherein the one or more processors are further configured to:
update the baseline variable at regular intervals to verify it reflects actual network requirements for applications.

11. The device of claim 10, wherein the one or more processors are further configured to:
utilize the baseline variable, after the upgrade action which can either be new hardware or software change, to automatically determine if one or more predetermined milestones are addressed.

12. The device of claim 10, wherein in case of any deviations it is reported immediately to a user or administrator.

13. A non-transitory computer-readable medium storing a set of instructions, the set of instructions comprising:
one or more instructions that, when executed by one or more processors of a device, cause the device to:
periodically collect network data, by a collection device, from a network using an API to create collected network data;
process collected network data for a uniform feed into an LLM to create processed data;
aggregate and normalize processed data and save to a data store as a baseline variable;
request from a network operator to verify whether an upgrade action is successful;
verify success of the upgrade action via a validation service which provides a set of preconfigured validation metrics;
provide detailed information on any deviations;
send a response to end user as a conversational text or visual graphs or reports based on request type.

14. The non-transitory computer-readable medium of claim 13, wherein metrics further comprise the number of BGP neighbors.

15. The non-transitory computer-readable medium of claim 14, wherein metrics further comprise storm control.

16. The non-transitory computer-readable medium of claim 15, wherein the one or more instructions further cause the device to:
update the baseline variable at regular intervals to verify it reflects actual network requirements for applications.

17. The non-transitory computer-readable medium of claim 16, wherein the one or more instructions further cause the device to:
utilize the baseline variable, after the upgrade action which can either be new hardware or software change, to automatically determine if one or more predetermined milestones are addressed.

18. The non-transitory computer-readable medium of claim 16, wherein in case of any deviations it is reported immediately to a user or administrator.
